(19) United States
(12) Patent Application Publication
(10) Pub. No.: US 2024/0032733 A1
(43) Pub. Date: Feb. 1, 2024

(54) MACHINE FOR HEATING AND AGITATING A LIQUID FOOD SUBSTANCE WITH SHUTDOWN DEVICE

(71) Applicant: SOCIETE DES PRODUITS NESTLE S.A., Vevey (CH)

(72) Inventors: PASCAL FRENZEL, Attalens (CH); ERIC GRANGER, Pully (CH); FRANK SCHNYDER, Vevey (CH)

(21) Appl. No.: 18/256,131

(22) PCT Filed: Dec. 7, 2021
(86) PCT No.: PCT/EP2021/084471

§ 371 Date: Jun. 6, 2023

(30) Foreign Application Priority Data
Dec. 7, 2020 (EP) 20212274.3

(51) Int. Cl. A47J 43/046; A47J 27/00

(52) U.S. Cl. CPC A47J 43/046; A47J 27/004

(57) ABSTRACT

The invention relates to a machine (1) that has: a tank (21) in which a liquid food substance, e.g. milk, is processed; a food substance agitator (4); a food substance heating surface (6); a temperature sensor (81) sensing a temperature of the heating surface (6) or of the liquid food substance; and a control unit (8) controlling an activation of the agitator (4) and of the heating surface (6). The control unit (8) is configured to deactivate the agitator (4) and the heating surface (6) by deactivating first the heating surface (6) and then later deactivating the agitator (4) at an end of a run-off time determined by the control unit (8) based on a run-off temperature that is sensed by the temperature sensor (81) after the heating surface (6) has been deactivated.

### FIELD OF THE INVENTION

The field of the invention pertains to machines for processing a liquid food substance, such as milk or a milk-based substance, by heating and agitating the substance in a tank.

### BACKGROUND ART

Specialty beverages in which at least a portion is made up of frothed or heated milk are becoming more and more popular. The best-known beverage of this type is a coffee of the cappuccino type. It comprises a liquid portion consisting of coffee topped by a layer of frothed milk which, because of its very much lower density, floats atop the surface of the liquid. In general, preparing one takes time, manipulation operations and cleaning.

The most customary way of preparing a milk-based froth is to pour the desired amount of milk into the container, immerse a steam outlet pipe from a coffee machine in the container, agitating it up and down to introduce the air needed to form the froth.

There also exists mechanical stirring appliances which are usually intended for domestic use for beating froth from more or less viscous food products such as eggs, ice, juices or the like. These appliances are usually ill-suited to froth the microbiologically sensitive liquids such as milk. Regular cleaning of the tank of the appliance needs to be envisaged in order to remove any solid food residue. In addition, heating the milk has a tendency to increase the extent to which cooked or burnt proteins are deposited on and adhere to the surfaces. The existing appliances are not, for the most part, well suited to reducing the encrustation of this solid residue, making cleaning troublesome. These appliances also have a stirring and drive mechanism which is fixed and intrudes into the tank, and this presents several disadvantages: the removal/refitting time is not insignificant, they have a tendency to become soiled more quickly, they entail additional cost as a result of the multiplicity of components, and the stirring means are difficult to clean.

U.S. Pat. No. 6,318,247 relates to an appliance for preparing hot beverages or food with stirring such as hot chocolate, for example. Other devices for stirring food products are described in patent documents WO 2004/043213, DE 89 15 094, DE 196 24 648, U.S. Pat. No. 2,932,493, DE 1,131,372, U.S. Pat. Nos. 3,356,349, 4,537,332 and 6,712,497. Improved appliances for preparing froth from a milk-based liquid or milk have been proposed in WO 2006/050900, WO 2008/142154, WO 2009/074555, WO 2010/023313, WO 2011/039222, WO 2011/039224, WO 2011/144647, PCT/EP20/069482 and PCT/EP20/069485. Such devices have typically: an inner tank for receiving the liquid that is to be frothed, in which a rotatable stirrer is positioned; an outer stand holding the tank; drive and control means which are in a cavity located between the inner tank and the outer stand, and which communicate with a switch and electrical connections located on the outer surface of the stand; and disturbance means to optimise circulation of the milk during frothing. Further devices for stirring food products such as milk-based products are disclosed in WO 2016/202814, WO 2016/202815, WO 2016/202816, WO 2016/202817, WO 2016/202818, WO 2018/108804, WO 2018/108807, WO 2018/108808, WO 2019/101764, WO 2019/101765, WO 2019/185782, WO 2019/185784, WO 2019/185785 and WO 2019/211213.

To avoid the burning of the liquid food substance against the heating surface in a processing tank, it has been proposed in WO 2017/098037 to alter the mixing actuation so as to displace the hot spots on the heating surface and avoid local overheating.

### SUMMARY OF THE INVENTION

It is a preferred object of the present invention to provide a machine for heating a liquid food substance, such as heating and optionally frothing milk or a milk-based liquid, while preventing or inhibiting the burning of the food substance.

The invention thus relates to a machine that has:
a tank for containing and processing a liquid food substance, such as milk or a milk-based substance;
an agitator, e.g. located in the tank, for imparting a mechanical effect on the liquid food substance in the tank;
a heating surface configured to be in contact with and heating the liquid food substance in the tank, e.g. a heating surface contained in or delimiting the tank and/or a heating surface delimiting the agitator, optionally the heating surface being associated with a heat generating device configured to supply heat to the heating surface such as an inductive heater device and/or a resistive heater device e.g. a resistive thick film or a discrete resistor; and
a temperature sensor, e.g. at least one of an NTC and PTC and thermocouple, for directly or indirectly sensing a temperature of the heating surface and/or of the liquid food substance in the tank.

The machine comprises a control unit that is connected to the temperature sensor and that is configured to control an activation of: the agitator to impart the mechanical effect on the liquid food substance in the tank; and the heating surface to heat the liquid food substance in the tank.

The control unit may include a controller and a memory device containing the programs and data to control the parts described herein.

The control unit is configured to deactivate the agitator and to deactivate the heating surface, for instance at completion of processing of the liquid food substance e.g. when the temperature sensor senses a completion temperature.

To deactivate the agitator and the heating surface, the control unit is configured to deactivate the heating surface and then later to deactivate the agitator at an end of a run-off time determined by the control unit based on a run-off temperature that is sensed by the temperature sensor after the heating surface has been deactivated and that is acquired by the control unit.

For example, the run-off time starts to run at deactivation of the heating surface or at acquisition of the run-off temperature (when the temperature is acquired only once by the control unit) or at acquisition of one of the run-off temperatures (when the temperature is acquired several times by the control unit).

Hence, at the end of the processing of the liquid food substance the agitator continues to agitate after the heating of the heating surface has been deactivated. The temperature is measured via the temperature sensor after deactivation of the heating surface, and optionally already before deactivation of the heating surface to be able to take into account also such measured temperatures. When the measured temperature indicates readiness to stop the agitator, e.g. to avoid overheating or even burning of the liquid food substance against the heating surface caused by an insufficient motion of the liquid food substance over the heating surface, the agitator is deactivated. Thus, a risk of undesired overheating (or burning) of the liquid over the (still too hot) heating surface can be reduced or even suppressed while keeping at the end of processing the agitator activated for only a short period of (and adjusted to each liquid food processing). Such a short period of time can be of the order of few seconds, as discussed below. The period of time will change depending on the nature and quantity of the liquid food substance in the tank as well as the heating of the heating surface during the processing and possibly also depending on the agitation of the liquid food substance in the tank (and the resulting froth or absence of froth that affects the thermal conductivity of the liquid food substance).

The machine may be a standalone machine, e.g. directly pluggable to the mains via an electric cord, or may be integrated in a food processor arranged to process other food items or to carry out different food conditioning processes, the food processor itself being generally pluggable to the mains via an electric cord whereas the machine is a sub-part of the food processor. Such a processor may be a beverage maker, for instance a coffee maker, e.g. a beverage maker configured to prepare a beverage (such as coffee) from an ingredient capsule.

Standalone and integrated associations of milk processing device and coffee makers are for example disclosed in WO 2006/050900, WO 2008/142154, WO 2009/074555, WO 2010/023312 and WO 2010/023313.

Typically, during the processing (and before the abovementioned deactivation) the heating of the heating surface, the moving of the agitator and, when provided for, the disturbance of the flow can be carried out generally at the same time.

The heating surface may be configured to provide heat by a heat generating device incorporating any of the features of the devices for stirring food products, e.g. for frothing a milk, disclosed in the state of the art references mentioned above.

The temperature sensor may be configured to sense a temperature of a part in thermal communication with the liquid food substance in the tank, e.g. a part of the tank and/or of the agitator and/or of the heating surface and/or a heat generating device associated with the heating surface.

The temperature sensor may be fixed to a heat generating device that has a support and a resistive heating track supported by the support (e.g. a PCB). The sensor can be supported by the support spaced apart from the heating track.

Hence, temperature changes of the heating surface or the heat generating device may be sensed by the sensor with a delay. An end or a flattening of a temperature increase or a temperature decrease of the heating surface may be sensed with a delay by the sensor, e.g. due to thermal inertia. This may result from various causes, such as a remote location of the sensor from the heating surface or from an uneven temperature of the heating surface (e.g. exhibiting hot spots), a low thermal conductivity of a material between the temperature sensor and the heating surface, e.g. a material selected from ceramic materials and polymer materials and semi-conductors and air and combinations thereof.

The support of the heat generating device can be made of a thermally non-conductive material (e.g. a non-conductive polymer or ceramic) and/or the support may be fixed to the tank adjacent to the heating surface or may form the heating surface.

The control unit can be configured to determine the run-off time:
by the sensed run-off temperature as such and/or by an evolution of the sensed run-off temperature that correspond(s) to (a) threshold value(s) or by a loop-control mechanism depending on the sensed run-off temperature, e.g. of a proportional and/or derivative and/or integrative type, e.g. linked to the control of the agitator; and/or
by taking further into account variations of temperatures sensed by the temperature sensor prior to deactivating the heating surface.

The control unit can be configured to continuously or intermittently, optionally at time intervals in the range of 0.001 to 1 sec. for instance 0.05 to 0.8 sec such as 0.15 to 0.6 sec. e.g. 0.2 to 0.4 sec., acquire the run-off temperature sensed by the temperature sensor after the heating surface is deactivated.

The control unit can be configured to deactivate the agitator when the acquired run-off temperature:
changes over time at a rate that is below a threshold value, for instance a threshold value that is below 0.5° C./sec., such as below 0.2° C./sec., e.g. below ° C., optionally below 0° C./sec.; and/or
reaches, e.g. passes below, a threshold value, such as a threshold value equal to a temperature sensed by the sensor when the heating surface is deactivated or a threshold value that is at least 0.1° C., such as at least 0.2° C., below the temperature sensed by the sensor when the heating surface is deactivated; and/or
has decreased, such as by at least 0.1° C. for example at least 0.4° C. e.g. at least 0.9° C., for instance after having reached a maximum temperature sensed by the sensor at or after deactivation of the heating surface.

The control unit may be configured to: acquire the run-off temperature sensed by the temperature sensor at a predetermined period of time, e.g. a predetermined period of time in the range of 0.2 to 3 sec. such as 0.5 to 2 sec. e.g. 0.75 to 1.5 sec., after the heating surface is deactivated; and then calculate the run-off time based on the acquired run-off temperature. The control unit may be configured to acquire a plurality, e.g. in the range of 2 to 5 such as 3 or 4, of run-off temperatures at different points in time, e.g. at time intervals in the range of 0.1 to 1 sec. such as 0.2 to 0.7 sec. e.g. 0.3 to 0.6 sec., at and after the predetermined period of time after the heating surface is deactivated and to calculate the run-off time based on the thereby acquired run-off temperatures.

The control unit may be configured to deactivate the heating surface and then later the agitator when a temperature sensed by the temperature sensor and acquired by the control unit reaches a predetermined processing threshold value after the heating surface has been activated, for instance a processing threshold value in the range of 50 to 85° C., such as 55 to 70° C., e.g. 60 to ° C.

The control unit can be configured to deactivate the heating surface and then later the agitator after a predetermined period of time after the control unit has activated the heating surface and/or the agitator. The predetermined period of time may be dependent on a level and/or profile of activation of the agitator and/or of the heating surface.

The control unit can have a safety mode in which the unit is configured to deactivate:
the agitator when reaching a cool-off safety time after the heating surface has been deactivated, for instance a cool-off safety time in the range of 5 to sec., such as 7 to 45 sec, e.g. 10 to 30 sec; and/or
the agitator and the heating surface when reaching a processing safety time after the agitator and/or the heating surface has been activated, for instance a processing safety time in the range of 120 to 240 sec. such as 140 to 180 sec e.g. 150 to 160 sec.

The safety time, typically pre-set, or run-off time of a particular processing will normally depend on the minimum expected volume of the liquid food substance to be processed in the tank and the geometry and thermal characteristics of the tank and optionally the position of the agitator. Typically, the smaller the volume of liquid food substance in the tank the slower the dissipation of heat via the substance and the longer the required run-off time and still longer safety time.

For example, the control unit is configured to deactivate after the processing safety time the heating surface and then later to deactivate the agitator at an end of a run-off time determined by the control unit based on a run-off temperature that is sensed by the temperature sensor after the heating surface has been deactivated and that is acquired by the control unit, e.g. as described above.

The control unit can be configured to activate the agitator and/or the heating surface to reach different levels and/or to follow different profiles of activation during processing, e.g. different agitator speeds and/or temperature profiles or levels, depending of requested, e.g. user-requested, characteristics of the liquid food substance upon processing. For example, the user may be given the opportunity to choose between different temperature and/or mixing and/or frothing characteristics of the liquid food substance upon processing.

Example of processes with different levels and/or profiles of temperature/speed are for exampled disclosed in PCT/EP20/069482.

The machine may have a powered chamber.

The powered chamber may include the control unit. The control unit can be associated with a user-interface such as one or more of push buttons and touch buttons and touch screens. The control unit may be associated with a data communication device such as a Wi-Fi or Bluetooth communication device for communication with a remote interface e.g. a smart phone or tablet.

The powered chamber can include a or the abovementioned heat generating device. The heat generating device may be adjacent to the heating surface. The heat generating device can be configured to transfer thermal and/or electromagnetic energy to the heating surface for its activation. The control unit typically controls the powering of the heat generating device.

The powered chamber may include a motor, e.g. an electric motor, for driving the agitator, such as a motor having an output axle and a magnetic coupling for driving magnetically the agitator. The control unit typically controls the powering of the motor.

The powered chamber can include a power input device, such as a connector to an external power supply. Such a connector may be fixed to the powered chamber and connected to or for connection to a corresponding connector fixed to a power base, e.g. having an electric cord for connection to a domestic power outlet. The connector may be a STRIX-type of connector.

The powered chamber may be adjacent to the tank.

The powered chamber can be delimited by a housing.

Such housing may extend to and optionally over at least part of the tank.

The tank can be fixed to or integral with the housing.

The tank may be user-separable from the housing, e.g. for dispensing the liquid food substance upon its processing.

The agitator can have a mobility in the tank when activated, such as a rotatability in the tank, for instance a rotatability about an axis that is at least one of parallel or skew or at an angle relative to a central axis of a processing cavity of the tank, the processing cavity containing the liquid food substance during processing. The tank axis is typically upright during the processing of the liquid food substance.

The agitator may include one or more impeller members configured to contact said liquid food substance to impart said mechanical effect thereto. For example, such impeller members are radially extending baffle members and/or annularly extending toroidal members, e.g. formed by a helicoidal spring, such as toroidal members mounted to one or more baffle members.

The agitator can comprise a mechanical connector movably connected to a corresponding connector of the tank.

The agitator can include one or more of magnetic and ferromagnetic elements for a or the abovementioned magnetic coupling to a or the abovementioned motor.

The agitator may have a configuration to impart the mechanical effect to the liquid food substance in the tank by rotating in the tank at a rotational speed in the range of 300 to 10000 RPM, for instance 500 to 7500 RPM, such as 900 to 5000 RPM, e.g. 1250 to 4250 RPM.

The agitator can have a configuration to impart the mechanical effect to said liquid food substance in the tank substantially permanently when the heating surface heats the liquid food substance in the tank.

The agitator may have a configuration to impart the mechanical effect to said liquid food substance in the tank prior to activating the heating surface, such as for a period of time of 3 to 15 sec, e.g. 5 to 10 sec, prior to activating the heating surface.

The tank can include a movable or removable lid for closing a mouth of the tank via which mouth the liquid food substance is supplied into and/or dispensed out of the tank. For example the mouth is provided with a dispensing spout that may be located at the mouth.

The tank may comprise at least one obstacle that interferes with a flow of said liquid food substance in the tank during processing.

Examples of such configurations (cavity with obstacle(s) and/or off-axis agitator movement) are disclosed for example in WO 2006/050900.

The tank may have a or the abovementioned central axis that forms a central axis of a or the abovementioned processing cavity of the tank. The processing cavity typically contains the liquid food substance during processing. The cavity can have a substantially cylindrical or parallelpipedic or frusto-conical or frusto-pyramidal shape extending along the central axis. This shape may be substantially uniform along the central axis or may be a combination of sections of the aforementioned different shapes.

The invention also relates to a method for preventing or inhibiting burning of a liquid food substance, such as milk or a milk-based substance, at an end of processing in a tank of a machine as described above. The method includes the steps of:
a) deactivating the heating surface; and then
b) acquiring by the control unit the run-off temperature sensed by the sensor after the heating surface has been deactivated and determining by the control unit the end of the run-off time based on the run-off temperature; and then
c) deactivating by the control unit the agitator at the end of the run-off time.

When this is completed, the processed liquid food substance may be ready for dispensing from the tank for consumption as such or for combination with another beverage ingredient (e.g. coffee or chocolate or cacao).

### BRIEF DESCRIPTION OF THE DRAWINGS

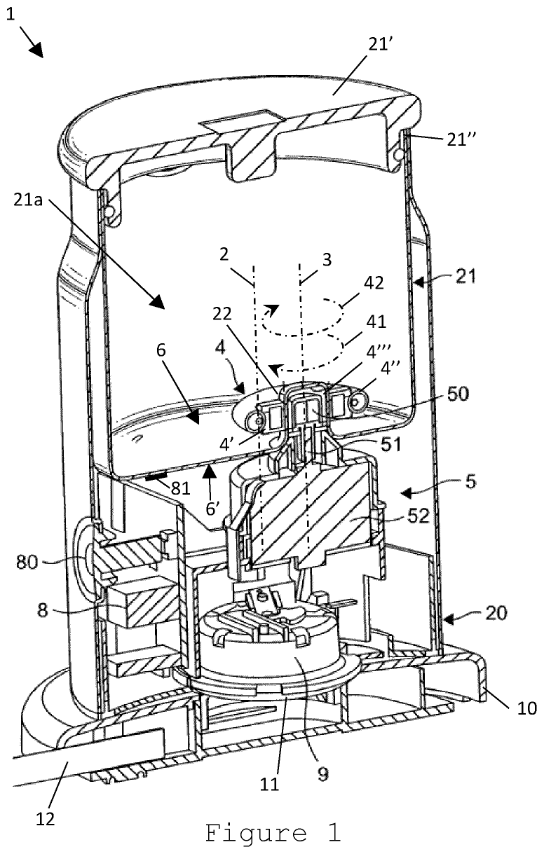

The invention will now be described with reference to the drawing in which FIG. 1 is a cross-sectional perspective view of a machine according to the invention.

### DETAILED DESCRIPTION

FIG. 1 shows a non-limiting embodiment of a machine 1 according to the invention.

Machine 1 has a tank 21 for containing and processing a liquid food substance, such as milk or a milk-based substance.

Machine 1 includes an agitator 4, e.g. located in tank 21, for imparting a mechanical effect on the liquid food substance in tank 21.

Machine 1 comprises a heating surface 6 configured to be in contact with and heating the liquid food substance in tank 21, e.g. a heating surface 6 contained in or delimiting tank 21 and/or a heating surface 6 delimiting agitator 4.

For example, heating surface 6 is associated with a heat generating device 6′ configured to supply heat to heating surface 6. Heat generating device 6′ may be an inductive heater device and/or a resistive heater device, e.g. a resistive thick film or a discrete resistor

Machine 1 has a temperature sensor 81 for directly or indirectly sensing a temperature of heating surface 6 and/or of the liquid food substance in the tank.

Machine 1 includes a control unit 8 connected to temperature sensor 81 and configured to control an activation of: agitator 4 to impart the mechanical effect on the liquid food substance in tank 21; and heating surface 6 to heat the liquid food substance in tank 21.

Control unit 8 is configured to deactivate agitator 4 and to deactivate heating surface 6, e.g. to deactivate a or the abovementioned heat generating device 6′ associated to heating surface 6, for instance at completion of processing of the liquid food substance e.g. when temperature sensor 81 senses a completion temperature.

To deactivate agitator 4 and heating surface 6, control unit 8 is configured to deactivate heating surface 6 and then later to deactivate agitator 4 at an end of a run-off time determined by the control unit 8 based on a run-off temperature that is sensed by temperature sensor 81 after heating surface 6 has been deactivated and that is acquired by control unit 8.

Temperature sensor 81 may be configured to sense a temperature of a part 4,6,6′,21 in thermal communication with the liquid food substance in tank 21, e.g. a part of tank 21 and/or of agitator 4 and/or of heating surface 6 and/or of a or the abovementioned heat generating device 6′ associated with heating surface 6.

Temperature sensor 81 may be fixed to a heat generating device 6′ that has a support and a resistive heating track supported by the support (e.g. a PCB), sensor 81 being supported by the support spaced apart from the heating track. The support can be made of a thermally non-conductive material. The support may be fixed to tank 21 adjacent to heating surface 6. The support may form heating surface 6.

Control unit 8 may be configured to determine the run-off time:
by the sensed run-off temperature as such and/or by an evolution of the sensed run-off temperature that correspond(s) to (a) threshold value(s) or by a loop-control mechanism depending on the sensed run-off temperature, e.g. of a proportional and/or derivative and/or integrative type, e.g. linked to the control of the agitator; and/or
by taking further into account variations of temperatures sensed by temperature sensor 81 prior to deactivating the heating surface.

Control unit 8 can be configured to continuously or intermittently, for example at time intervals in the range of 0.001 to 1 sec. for instance 0.05 to 0.8 sec such as 0.15 to 0.6 sec. e.g. 0.2 to 0.4 sec., acquire the run-off temperature sensed by temperature sensor 81 after heating surface 6 is deactivated.

Control unit 8 may be configured to deactivate agitator 4 when the acquired run-off temperature:
changes over time at a rate that is below a threshold value, for instance a threshold value that is below 0.5° C./sec., such as below 0.2° C./sec., e.g. below ° C., optionally below 0° C./sec.; and/or
reaches, e.g. passes below, a threshold value, such as a threshold value equal to a temperature sensed by sensor 81 when heating surface 6 is deactivated or a threshold value that is at least 0.1° C., such as at least 0.2° C., below the temperature sensed by sensor 81 when heating surface 6 is deactivated; and/or
has decreased, such as by at least 0.1° C. for example at least 0.4° C. e.g. at least 0.9° C., for instance after having reached a maximum temperature sensed by sensor 81 at or after deactivation of heating surface 6.

Control unit 8 may be configured to:
acquire the run-off temperature sensed by temperature sensor 81 at a predetermined period of time, e.g. a predetermined period of time in the range of 0.2 to 3 sec. such as 0.5 to 2 sec. e.g. 0.75 to 1.5 sec., after heating surface 6 is deactivated; and
calculate the run-off time based on the acquired run-off temperature.

Control unit 8 can be configured to acquire a plurality, e.g. in the range of 2 to 5 such as 3 or 4, of run-off temperatures at different points in time, e.g. at time intervals in the range of 0.1 to 1 sec. such as 0.2 to 0.7 sec. e.g. 0.3 to 0.6 sec., at and after the predetermined period of time after the heating surface is deactivated and to calculate the run-off time based on the thereby acquired run-off temperatures.

Control unit 8 may be configured to deactivate heating surface 6 and then later agitator 4 when a temperature sensed by temperature sensor 81 and acquired by control unit 8 reaches a predetermined processing threshold value after heating surface 6 has been activated, for instance a processing threshold value in the range of 50 to 85° C., such as 55 to 70° C., e.g. 60 to 65° C.

Control unit 8 can be configured to deactivate heating surface 6 and then later agitator 4 after a predetermined period of time after control unit 8 has activated heating surface 6 and/or agitator 4. The predetermined period of time may be dependent on a level and/or profile 41, 42 of activation of agitator 4 and/or of heating surface 6. For example, after start-up, agitator 4 may be moved at different speeds 41, 42 when the liquid food substance is processed in tank 21.

Control unit 8 may have a safety mode in which unit 8 is configured to deactivate:
agitator 4 when reaching a cool-off safety time after heating surface 6 has been deactivated, for instance a cool-off safety time in the range of 5 to 60 sec., such as 7 to 45 sec, e.g. 10 to 30 sec; and/or
agitator 4 and heating surface 6 when reaching a processing safety time after agitator 4 and/or heating surface 6 has/have been activated, for instance a processing safety time in the range of 120 to 240 sec., such as 140 to 180 sec, e.g. 150 to 160 sec., optionally control unit 8 being configured to deactivate after the processing safety time heating surface 6 and then later to deactivate agitator 4 at an end of a run-off time determined by control unit 8 based on a run-off temperature that is sensed by temperature sensor 81 after heating surface 6 has been deactivated and that is acquired by control unit 8.

Control unit 8 can be configured to activate agitator 4 and/or heating surface 6 to reach different levels and/or to follow different profiles 41, 42 of activation during processing, e.g. different agitator speeds and/or temperature profiles or levels 41, 42, depending of requested, e.g. user-requested, characteristics of the liquid food substance upon processing, such as different temperature and/or mixing and/or frothing characteristics.

Machine 1 may have a powered chamber 5.

Chamber 5 may contain control unit 8. Such control unit 8 may be associated with: a user-interface 80, such as one or more of push buttons and touch buttons and touch screens; and/or a data communication device such as a Wi-Fi or Bluetooth communication device for communication with a remote interface e.g. a smart phone or tablet.

Chamber 5 may contain a or the abovementioned heat generating device 6′. For example, heat generating device 6′ is adjacent to heating surface 6. Heat generating device 6′ may be configured to transfer thermal and/or electromagnetic energy to heating surface 6 for its activation, control unit 8 typically controlling the powering of heat generating device 6′.

Chamber 5 may contain a motor 52, e.g. an electric motor, for driving agitator 4. Motor 52 may have an output axle 51 and a magnetic coupling 50 for driving magnetically agitator 4. Control unit 8 typically controls the powering of motor 52.

Chamber 5 may contain a power input device 9, such as a connector to an external power supply. The connector may be fixed to powered chamber 5 and connected to or for connection to a corresponding connector 11 fixed to a power base 10, e.g. having an electric cord 12 for connection to a domestic power outlet.

Powered chamber 5 may be adjacent to tank 21.

Powered chamber 5 can be delimited by a housing 20. Housing 20 may extend to and optionally over at least part of tank 21. Tank 21 can be fixed to or integral with housing 20 or tank 21 can be user-separable from housing e.g. for dispensing the liquid food substance upon processing thereof.

Agitator 4 can have a mobility in tank 21 when activated, such as a rotatability in tank 21, for instance a rotatability about an axis 3 that is at least one of parallel or skew or at an angle relative to a central axis 2 of a processing cavity 21a of tank 21 which processing cavity 21a contains the liquid food substance during processing. Tank axis 2 can be upright during the processing of the liquid food substance.

Agitator 4 may include one or more impeller members 4′, 4″, e.g. radially extending baffle members 4′ and/or annularly extending toroidal members 4″ such as toroidal members 4″ mounted to one or more baffle members 4′, configured to contact the liquid food substance to impart the mechanical effect thereto.

Agitator 4 can have a mechanical connector 4′″ movably connected to a corresponding connector 22 of tank 21.

Agitator 4 can comprise one or more of magnetic and ferromagnetic elements for a or the abovementioned magnetic coupling 50 to a or the abovementioned motor 52.

Agitator 4 may have a configuration to impart the mechanical effect to the liquid food substance in tank 21 by rotating in tank 21 at a rotational speed 41, 42 in the range of 300 to 10000 RPM, for instance 500 to 7500 RPM, such as 900 to 5000 RPM, e.g. 1250 to 4250 RPM.

Agitator 4 can have a configuration to impart the mechanical effect to the liquid food substance in tank 21 substantially permanently when heating surface 6 heats the liquid food substance in tank 21.

Agitator 4 may have a configuration to impart the mechanical effect to the liquid food substance in tank 21 prior to activating heating surface 6, such as for a period of time of 3 to 15 sec, e.g. 5 to 10 sec, prior to activating heating surface 6.

Tank 21 may include a movable or removable lid 21′ for closing a mouth 21″ of tank 21 via which mouth 21″ the liquid food substance is supplied into and/or dispensed out of tank 21. Mouth 21″ may be provided with a dispensing spout e.g. located at mouth 21″.

Tank 21 can incorporate at least one obstacle that interferes with a flow of the liquid food substance in tank 21 during processing.

Tank 21 may have a or the abovementioned central axis 2 that forms a central axis of a or the abovementioned processing cavity 21a of tank 21 which processing cavity 21a contains the liquid food substance during processing. Cavity 21a may have a substantially cylindrical or parallelpipedic or frusto-conical or frusto-pyramidal shape extending along central axis 2.

The invention also relates to a method for preventing or inhibiting burning of a liquid food substance, such as milk or a milk-based substance, at an end of processing in a tank of a machine as described above. The method includes the steps of:

At the end of processing the liquid food substance in tank 21, heating surface 6 is deactivated and then the deactivating the heating surface; then the run-off temperature is sensed by sensor 81 after the heating surface has been deactivated and the sensed run-off temperature is acquired by control unit 8 to determine the run-off time based on the run-off temperature; then control unit 8 deactivates agitator 4. When this is completed, the processed liquid food substance may be ready for dispensing from tank 21 for consumption as such or for combination with another beverage ingredient (e.g. coffee or chocolate or cacao).

1. A machine comprising:
a tank for containing and processing a liquid food substance;
an agitator for imparting a mechanical effect on said liquid food substance in the tank;
a heating surface configured to be in contact with and heating said liquid food substance in the tank;
a temperature sensor for directly or indirectly sensing a temperature of the heating surface and/or of said liquid food substance in the tank; and
a control unit connected to the temperature sensor and configured to control an activation of:
the agitator to impart the mechanical effect on said liquid food substance in the tank; and
the heating surface to heat said liquid food substance in the tank,
the control unit being configured to deactivate the agitator and to deactivate the heating surface,
wherein to deactivate the agitator and the heating surface, the control unit is configured to deactivate the heating surface and then later to deactivate the agitator at an end of a run-off time determined by the control unit based on a run-off temperature that is sensed by the temperature sensor after the heating surface has been deactivated and that is acquired by the control unit.

2. The machine of claim 1, wherein the temperature sensor is configured to sense a temperature of a part in thermal communication with said liquid food substance in the tank.

3. The machine of claim 1, wherein the control unit is configured to determine the run-off time:
by the sensed run-off temperature as such and/or by an evolution of the sensed run-off temperature that correspond(s) to (a) threshold value(s) or by a loop-control mechanism depending on the sensed run-off temperature; and
by taking further into account variations of temperatures sensed by the temperature sensor prior to deactivating the heating surface.

4. The machine of claim 1, wherein the control unit is configured to continuously acquire the run-off temperature sensed by the temperature sensor after the heating surface is deactivated.

5. The machine of claim 4, wherein the control unit is configured to deactivate the agitator when the acquired run-off temperature:
changes over time at a rate that is below a threshold value, for instance a threshold value that is below 0.5° C./sec.

6. The machine of claim 1, wherein the control unit is configured to:
acquire the run-off temperature sensed by the temperature sensor at a predetermined period of time after the heating surface is deactivated; and
calculate the run-off time based on the acquired run-off temperature.

7. The machine of claim 6, wherein the control unit is configured to acquire a plurality of run-off temperatures at different points in time at and after the predetermined period of time after the heating surface is deactivated and to calculate the run-off time based on the thereby acquired run-off temperatures.

8. The machine of claim 1, wherein the control unit is configured to deactivate the heating surface and then later the agitator when a temperature sensed by the temperature sensor and acquired by the control unit reaches a predetermined processing threshold value after the heating surface has been activated.

9. The machine of claim 1, wherein the control unit is configured to deactivate the heating surface and then later the agitator after a predetermined period of time after the control unit has activated the heating surface and/or the agitator, optionally the predetermined period of time is dependent on a level of activation of the agitator.

10. The machine of claim 1, wherein the control unit has a safety mode in which the unit is configured to deactivate:
the agitator when reaching a cool-off safety time after the heating surface has been deactivated; and
the agitator and the heating surface when reaching a processing safety time after the agitator and the heating surface have been activated.

11. The machine of claim 1, wherein the control unit is configured to activate the agitator and/or the heating surface to reach different levels and/or to follow different profiles of activation during processing.

12. The machine of claim 1, which comprises a powered chamber containing at least one component selected from the group consisting of:
the control unit with a user-interface;
a heat generating device;
a motor for driving the agitator; and
a power input device.

13. The machine of claim 1, wherein the agitator has at least one element selected from the group consisting of:
a mobility in the tank when activated;
one or more impeller members annularly extending toroidal members;
a mechanical connector movably connected to a corresponding connector of the tank;
one or more of magnetic and ferromagnetic elements;
a configuration to impart the mechanical effect to said liquid food substance in the tank by rotating in the tank at a rotational speed;
a configuration to impart the mechanical effect to said liquid food substance in the tank substantially permanently when the heating surface heats said liquid food substance in the tank; and
a configuration to impart the mechanical effect to said liquid food substance in the tank prior to activating the heating surface.

14. The machine of claim 1, wherein the tank has at least one element selected from the group consisting of:
a movable or removable lid for closing a mouth of the tank via which mouth said liquid food substance is supplied into and/or dispensed out of the tank;
at least one obstacle that interferes with a flow of said liquid food substance in the tank during processing; and
a central axis that forms a central axis of a or said processing cavity of the tank which processing cavity contains the liquid food substance during processing.

15. A method for preventing or inhibiting burning of a liquid food substance, such as milk or a milk-based substance, at an end of processing in a tank of a machine comprising:
a tank for containing and processing a liquid food substance;
an agitator for imparting a mechanical effect on said liquid food substance in the tank;
a heating surface configured to be in contact with and heating said liquid food substance in the tank;
a temperature sensor for directly or indirectly sensing a temperature of the heating surface and/or of said liquid food substance in the tank; and
a control unit connected to the temperature sensor and configured to control an activation of:
the agitator to impart the mechanical effect on said liquid food substance in the tank; and
the heating surface to heat said liquid food substance in the tank,
the control unit being configured to deactivate the agitator and to deactivate the heating surface,
wherein to deactivate the agitator and the heating surface, the control unit is configured to deactivate the heating surface and then later to deactivate the agitator at an end of a run-off time determined by the control unit based on a run-off temperature that is sensed by the temperature sensor after the heating surface has been deactivated and that is acquired by the control unit comprising the steps of:
deactivating said heating surface; and then
acquiring by the control unit the run-off temperature sensed by the sensor after the heating surface has been deactivated and determining by the control unit said end of the run-off time based on the run-off temperature; and then
deactivating by the control unit the agitator at the end of the of the run-off time.
